(19) United States
(12) Patent Application Publication
(10) Pub. No.: US 2025/0260300 A1
(43) Pub. Date: Aug. 14, 2025

(54) VIBRATORY MOTOR WITH STROKE CONTROL

(71) Applicant: WAHL CLIPPER CORPORATION, Sterling, IL (US)

(72) Inventor: Drew Paul MITCHELL, Polo, IL (US)

(21) Appl. No.: 18/856,987

(22) PCT Filed: May 2, 2023
(86) PCT No.: PCT/US2023/020645

§ 371 Date: Oct. 15, 2024

(30) Foreign Application Priority Data
Jun. 22, 2022 (US) 63366801

(51) Int. Cl. H02K 33/02; B26B 19/28; H02K 11/33

(52) U.S. Cl. CPC H02K 33/02; B26B 19/282; H02K 11/33

(57) ABSTRACT

A hair clipper has a fixed blade, a reciprocating blade and a vibratory motor. The vibratory motor has a reciprocating armature operatively connected to the reciprocating blade, an electromagnet and a spring. The armature and the electromagnet are separated by an air gap. The armature moves during operation, which causes the air gap to change as the armature reciprocates. The electromagnet has a wire wound around a metallic core to form a plurality of windings. The electromagnet has an inductance that varies as the armature reciprocates and the air gap changes. A first end of the wire is electrically connected to an alternating current power source, and a second end of the wire is electrically connected to a first lead of a capacitor. The capacitor has a second lead which is electrically connected to the alternating current power source.

### RELATED APPLICATION

This Patent Convention Treaty (PCT) International Application claims the benefit under 35 US 119(e) of U.S. Provisional Application Ser. No. 63/366,801 filed Jun. 22, 2022, the entire contents of which are incorporated by reference herein.

### FIELD OF THE INVENTION

This invention relates to vibratory motors, and more particularly, to vibratory motors for hair clippers.

### BACKGROUND OF THE INVENTION

Hair clippers have a stationary blade and a reciprocating blade. The blades have cutting teeth that cooperate to cut hair strands that come between the teeth as the reciprocating blade teeth move back and forth against the stationary blade teeth. The reciprocating blade in many clippers is driven by a vibratory motor.

Vibratory motors use an electromagnet and a sprung armature to move the moving blade back and forth across the stationary blade. The relative displacement of the two blades with respect to one another is referred to as the stroke. The stroke of a clipper must maintain a minimum value to cut hair without pulling or snagging hair. The minimum stroke is set by the geometry of the blade pair, but every blade pair will have a minimum viable stroke. Thus, it is important for a hair clipper to be able to maintain stroke under load, i.e., cutting hair, or it could fall below its minimum viable stroke and begin pulling the hair intended to be cut.

Vibratory motor constructions are susceptible to loss of stroke under load, as there is no mechanical coupling between the two blades. The stroke is dictated by the strength of the magnet and the vibrational dynamics (e.g., natural frequency, damping, load, etc.) of the system. Vibratory motors are also limited in strength due to thermal constraints, as the ohmic losses in the electromagnet can generate large amounts of heat that can put a limit on the amount of magnetomotive force that can be generated. Thus, there is a need for more efficient vibratory motors.

Accordingly, one object of this invention is to provide new and improved vibratory motors.

Another object is to provide new and improved vibratory motors for hair clippers.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a plan view of a hair clipper having a vibratory motor;

FIG. 2 is a schematic of a vibratory motor in accordance with this invention;

FIG. 3 is a graph showing the amplitude of current flowing as a function of inductance and capacitance for a fixed supply voltage in the vibratory motor of FIG. 2;

FIG. 4 is a graph of a test comparing the stroke over various loads of (a) a vibratory motor made in accordance with this invention with (b) a conventional vibratory motor;

FIG. 5 is a graph of inductance in a vibratory motor over various air gaps;

FIG. 6A is a contour plot of free stroke as a function of system spring constant and system capacitance;

FIG. 6B is a contour plot of stroke ratio as a function of system spring constant and system capacitance;

FIG. 6C is a contour plot of power as a function of the system spring constant and the system capacitance;

FIG. 6D is a contour plot of the voltage across the capacitor as a function of the system spring constant and the system capacitance; and

FIG. 6E is another contour plot of the voltage across the capacitor as a function of the system spring constant and the system capacitance.

### DETAILED DESCRIPTION

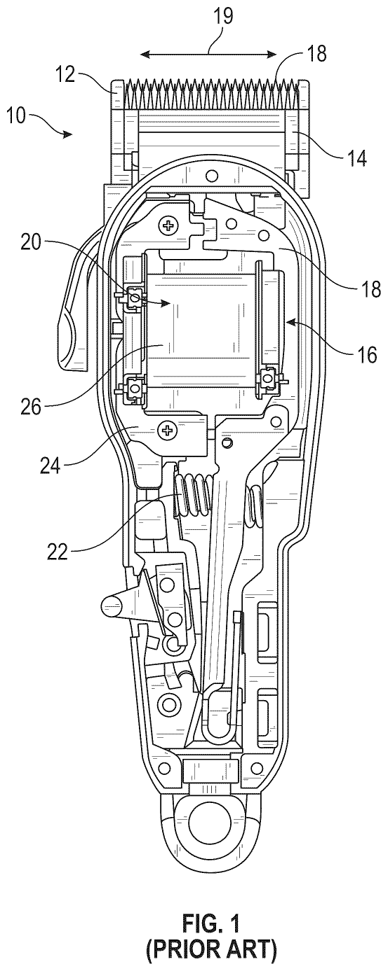

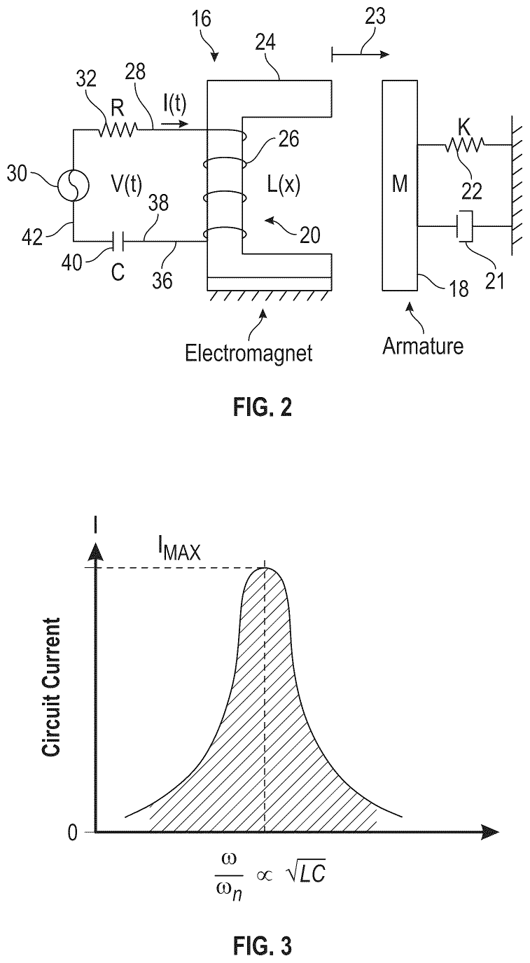

As seen in FIGS. 1 and 2, a hair clipper 10 has a fixed blade 12, a reciprocating blade 14 and a vibratory motor 16. The reciprocating blade 14 and the stationary blade 12 have teeth 18 that cut hair which enters the spaces between the teeth as the reciprocating blade 14 moves back and forth in the directions of the arrows 19. The overall construction of the hair clipper is described in more detail in U.S. Pat. No. 8,276,279, which is incorporated by reference in its entirety. While described in the context of a hair clipper, those of skill in the art will recognize, however, that the invention is not limited to a hair clipper application. Indeed, the Applicant has found that the invention may be readily applied to any electromagnetic motor having the constituent componentry described herein.

The motor 16 has an armature 18 operatively connected to the reciprocating blade 14, an electromagnet 20 and a spring 22. An air gap 23 between the electromagnet 20 and the armature 18 allows the armature 18 to reciprocate. The air gap 23 changes as the armature 18 moves back and forth under the operation of the electromagnetic motor 20.

The electromagnet 20 has a metallic core 24 and a wire 26 (FIG. 2) wound around the metallic core 24 to form a plurality of windings surrounding the metallic core 24. The wire 26 has an inherent electrical resistance. A first end 28 is connected to an alternating current power source 30 through a resistor 32 (not shown in FIG. 1), and a second end 36 is connected to a first lead 38 of a capacitor 40 (not shown in FIG. 1). The capacitor 40 has a second lead 42 connected to the alternating current power source 30.

With the inclusion of the capacitor 40, a circuit capable of electrical resonance is formed. Electrical resonance, like mechanical resonance, maximizes the oscillation amplitude for a given input. The resistance of the wire is a parameter that controls the bandwidth of the resonant peak. The resistor 32, if present, is another parameter to control the bandwidth of the resonant peak.

As mentioned above, the above-introduced embodiment presents a circuit capable of resonance. Depending on the selection of the value of capacitance of the capacitor 40, the system can be designed to be near electrical resonance. When the system is designed near electrical resonance, putting a load on the system moves the system closer to electrical resonance and effectively increases the strength of the electromagnet. Since the stroke increases with increasing electromagnet strength, the clipper is better able to maintain its stroke under load. The inclusion of a capacitor can also produce a more efficient motor. By including a capacitor, more turns can be added to the inductor without the inductive impedance penalty because the inductive impedance can be offset by the capacitor, resulting in less ohmic loss in the motor windings and less heat generated within the motor.

The dynamics of this system are determined by the electrical and mechanical coupling within the system. The addition of an appropriately sized capacitor 40 thus takes advantage of the interaction between the two parts of the system to produce a vibratory motor that can maintain stroke under load, while also resulting in a more efficient, cooler running motor. Maintaining stroke under load is very important in the context of a hair clipper. Conventional hair clippers will lose stroke under increased loading. A loss of stroke can result in hair pulling and snagging as mentioned above. A cooler running motor is also advantageous in that hair clipper will not transfer as much heat to the blades as conventional clippers do, resulting in a cooler feeling when the hair clipper is in contact with the skin.

The embodiment of the circuit according to the invention described above can resonate when driven at the correct frequency. Resonance, in this context, means that the RMS current flowing is at a maximum for a given supply voltage because the inductive and capacitive impedance cancel. The natural frequency wn (the frequency around which the circuit will resonate) depends on the inductance, L, and the capacitance, C, of the circuit and is

$${ω}_{n} = \sqrt{\frac{1}{LC}} .$$

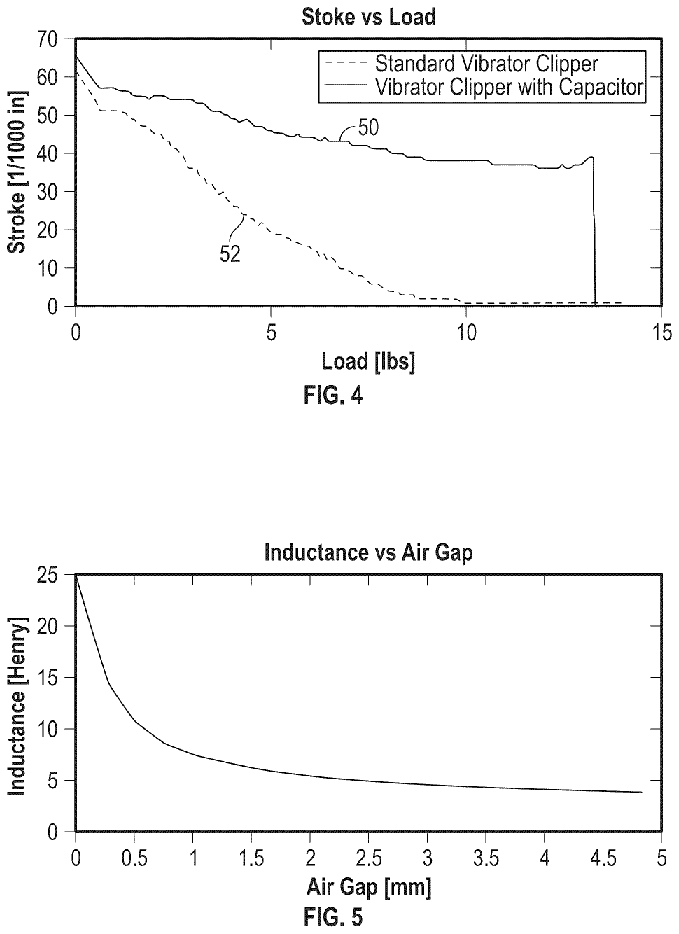

An illustration of the amplitude of the current flowing as a function of the inductance and capacitance for a fixed supply voltage is shown in FIG. 3. The natural frequency of the hair clipper circuit can be tuned to the supply (wall/outlet) voltage frequency (50 Hz or 60 Hz, for example), @, such that it is near resonance.

The inductance, L, depends on the gap 23 between the electromagnet 20 and the armature (FIG. 2). When the value of the capacitor 40 is chosen correctly, the act of loading the clipper causes the inductance, L, to change in such a way as to bring the electrical system closer to resonance. This means that when a load is applied, the circuit responds by sending more current through the electromagnet, allowing the motor to maintain stoke under load better than contemporary designs.

Another benefit of adding a capacitor to the circuit is improved motor efficiency. The strength of an electromagnet or its Magnetomotive Force (MMF) is defined as the product of the number of turns, N, and the current flowing, I. The energy dissipated and thus the heat generated by the motor is equal the product of electrical resistance, R, and current flowing, I, squared. In a vibratory motor without a capacitor such as that present in existing designs, the current flowing is proportional the 1/N\hat{ }2 and thus the MMF of the motor is proportional to 1/N. So, to make a motor stronger, turns must be removed, resulting in more current flowing and more heat being generated. However, in the instant invention as described by the embodiments herein, a circuit including capacitor 40 operating near resonance, the current flowing is independent of the number of turns on the coil and thus the turns/current ratio can be adjusted while keeping the MMF the same (i.e., double turns and half current keeps the MMF the same). By reducing current, ohmic loss is reduced, efficiency is improved, and heat generation is reduced while maintaining motor strength.

In experiments conducted by the Applicant, a hair clipper was created that allowed for the addition and removal of a capacitor. This hair clipper was then tested in a fixture that can measure the load applied to the blade (in the form of friction) while also measuring the stroke. The power consumption of the clipper without a capacitor 40 was about 10 watts. The power consumption of the clipper with the capacitor 40 in the circuit was around 4 watts.

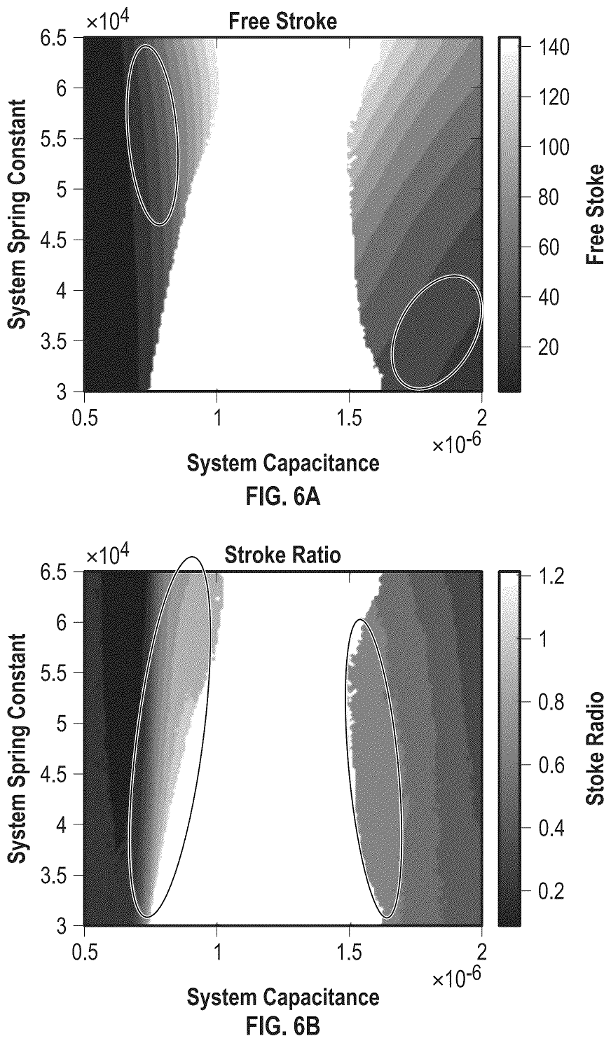

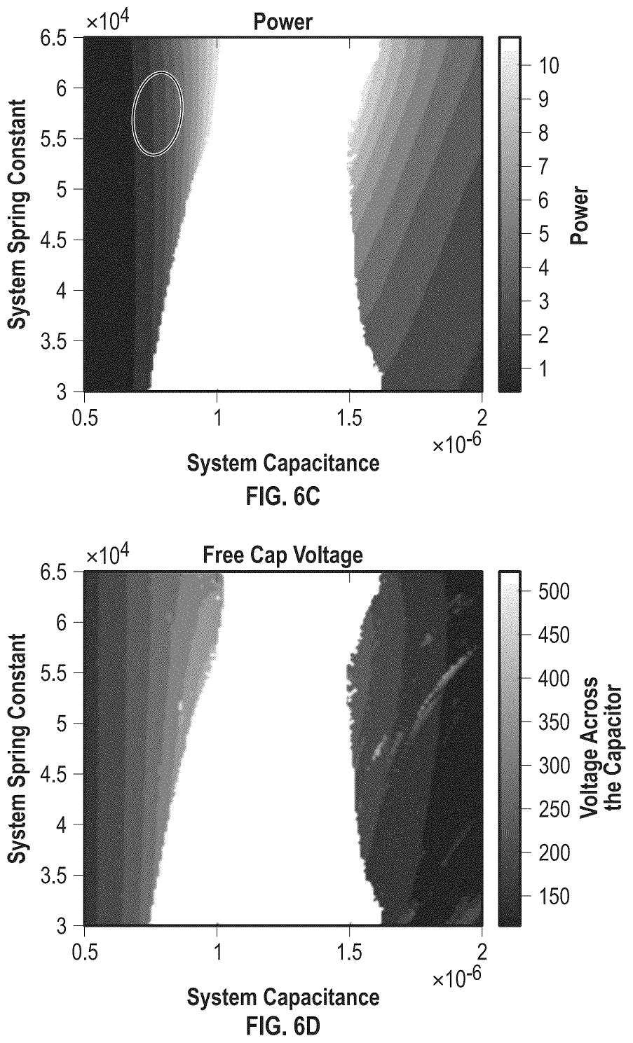

Turning now to FIG. 4, the two lines shown therein are for the same clipper, but in line 50, there is a capacitor 40 in series with the motor 16 and in line 52, there is not. The test with the capacitor installed shows that the clipper is better able to maintain stroke than when the unit is run without a capacitor. The testing fixture used a load cell to measure the clamping force between the blades, which simulates a load on the motor as it increases friction between the blades. The motor was tested with a nominal voltage of 220V at 60 hz across the electromagnet. For the clipper construction used in testing, the capacitance was 0.88 uF, the resistance was 260 ohms, and the inductance varied (depending on armature location) between 4 and 25 Henry (H), as shown in FIG. 5.

An air gap typically varies between about 1 mm and about 4 mm, with 3 mm being nominal. In the example of FIG. 5, the inductance is about 7H when the air gap is 1 mm, 5H when the air gap is 3 mm, and 4H when the air gap is 4 mm.

The potential values of capacitance depend on the construction and operating point of a particular motor, for example, the shape and magnitude of the inductance vs air gap curve, the electrical source frequency, the natural frequency of the mechanical system, etc. The value could conceivably be from 1 pF up to 1 F depending on the motor inductance and driving frequency.

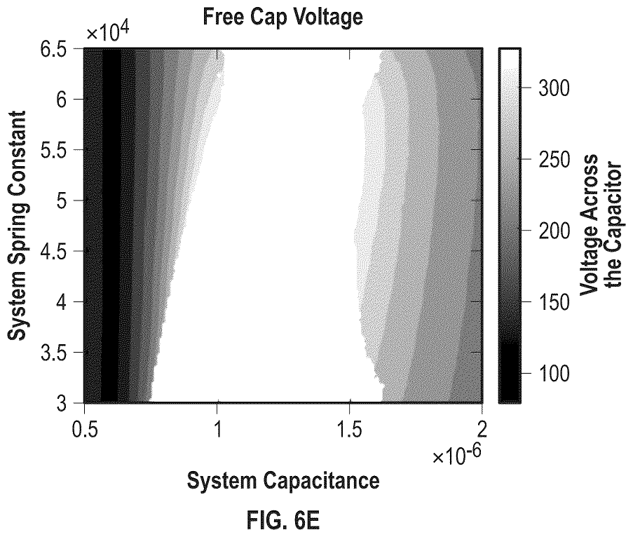

Values of the components can be determined using contour plots, as seen in FIGS. 6A-6E. In FIG. 6A, the left side ordinate indicates the system spring constant and the right side ordinate indicates free stroke. The abscissa indicates the system capacitance. In FIG. 6B, the left side ordinate indicates the system spring constant and the right side ordinate indicates the stroke ratio. The abscissa indicates the system capacitance. In FIG. 6C, the left side ordinate indicates the system spring constant and the right side ordinate indicates power. The abscissa indicates the system capacitance. In FIG. 6D, the left side ordinate indicates the system spring constant and the right side ordinate indicates the voltage across the capacitor. The abscissa indicates the system capacitance. In FIG. 6E, the left side ordinate indicates the system spring constant and the right side ordinate indicates the voltage across the inductor. The abscissa indicates the system capacitance.

The design process starts with a target free stroke. For the example in FIG. 6A, the target is a stroke between 30 and 60 thousandths of an inch. The circled spots indicate operation points that satisfy that stroke condition.

The next consideration is stroke ratio, studied in FIG. 6B. This is the ratio of loaded/free stroke and is a measure of how well the motor holds its stroke under load. For example, for a minimum stroke ratio of 0.70, the stroke will have decreased by no more than 30%.

FIG. 6C studies the point within all the circles thus far that minimizes power consumption. The circle in FIG. 6C satisfies all other previous requirements and minimizes the power consumed.

The free capacitor voltage (FIG. 6D) is another variable which can be used to specify the rating of the capacitor, and motor voltage measurements (FIG. 6E) can be used to specify the electrical shielding needed on the wires.

Advantages of the invention are now apparent. More efficient, cooler running vibratory motors are produced.

1. A hair clipper comprising a fixed blade, a reciprocating blade and a vibratory motor,
the vibratory motor having a reciprocating armature operatively connected to the reciprocating blade, an electromagnet and a spring, the armature and the electromagnet being separated by an air gap, wherein the armature moves during operation, which causes the air gap to change as the armature reciprocates;
the electromagnet having a metallic core and a wire wound around the metallic core to form a plurality of windings surrounding the metallic core, the electromagnet having an inductance that varies as the armature reciprocates and the air gap changes, the wire having electrical resistance,
a first end of the wire being electrically connected to an alternating current power source, and a second end of the wire being electrically connected to a first lead of a capacitor, the capacitor having a second lead which is electrically connected to the alternating current power source.

2. The hair clipper of claim 1 comprising a resistor connected in series with the first lead or the second lead of the capacitor.

3. A vibratory motor comprising a reciprocating armature operatively connected to a load,
an electromagnet and a spring, the armature and the electromagnet being separated by an air gap, wherein the armature moves during operation, which causes the air gap to change as the armature reciprocates;
the electromagnet having a metallic core and a wire wound around the metallic core to form a plurality of windings surrounding the metallic core, the electromagnet having an inductance that varies as the armature reciprocates and the air gap changes, the wire having electrical resistance,
a first end of the wire being electrically connected to an alternating current power source, and a second end of the wire being electrically connected to a first lead of a capacitor, the capacitor having a second lead which is electrically connected to the alternating current power source.

4. The vibratory motor of claim 3 comprising a resistor connected in series with the first lead or the second lead of the capacitor.
